(19) United States
(12) Patent Application Publication
(10) Pub. No.: US 2022/0300848 A1
(43) Pub. Date: Sep. 22, 2022

(54) Function Processing Method and Device and Electronic Apparatus

(71) Applicant: Beijing Baidu Netcom Science Technology Co., Ltd., Beijing (CN)

(72) Inventors: Kun FANG, Beijing (CN); Runyao DUAN, Beijing (CN)

(21) Appl. No.: 17/835,666

(22) Filed: Jun. 8, 2022

(30) Foreign Application Priority Data
Jun. 8, 2021 (CN) 202110636547.0

(51) Int. Cl. G06N 10/40; G06N 10/20; G06N 10/80; G06F 17/16

(52) U.S. Cl. CPC G06N 10/40; G06N 10/20; G06N 10/80; G06F 17/16

(57) ABSTRACT

A function processing method and device, and an electronic device are provided. The function processing method includes: obtaining a first polynomial function including a plurality of terms consisting of a plurality of first variables; constructing a node route diagram of a quantum approximate optimization algorithm (QAOA) based on the first polynomial function, where the node route diagram includes K nodes, K is determined based on the first polynomial function, and K is an integer greater than 1; generating quantum entangled states of the node route diagram, where the quantum entangled states include target quantum states of the K nodes in the node route diagram; and sequentially performing a numerical measurement on each node in the K nodes based on the target quantum state of the K nodes in the node route diagram, to obtain a first target numerical measurement result of the plurality of first variables.

### CROSS-REFERENCE TO RELATED APPLICATIONS

This application claims priority to Chinese Patent Application No. 202110636547.0 filed in China on Jun. 8, 2021, the entire contents of which are incorporated herein by reference.

### TECHNICAL FIELD

The present disclosure relates to the field of quantum computing technologies, and in particular, to an evolutionary computing technology in quantum computing, and in particular, to a function processing method and device, and an electronic device.

### BACKGROUND

The Polynomial combination optimization problem is a basic problem in graph theory and combination optimization, and is also a Non-deterministic Polynomial (NP)-difficult problem proved to be a Polynomial complexity degree, and refers to determining values of variables in a Polynomial function, where the value of each variable is 0 or 1, so that the function value of the Polynomial function is maximum, and the Polynomial combination optimization problem is widely applied to various fields of statistical physics, image processing, network design, super-large scale integrated circuit design, data cluster analysis, signal processing, image reconstruction in computer vision and the like.

Currently, a polynomial combination Optimization problem can be approximated by a Quantum Approximation Optimization Algorithm (QAOA), which typically evolves in a Quantum circuit model.

### SUMMARY

The disclosure provides a function processing method and device and electronic apparatus.

According to a first aspect of the present disclosure, a function processing method is provided, including:

obtaining a first polynomial function including a plurality of terms consisting of a plurality of first variables;

constructing a node route diagram of a quantum approximate optimization algorithm (QAOA) based on the first polynomial function, where the node route diagram includes K nodes, K is determined based on the first polynomial function, and K is an integer greater than 1;

generating quantum entangled states of the node route diagram, where the quantum entangled states include target quantum states of the K nodes in the node route diagram; and

sequentially performing a numerical measurement on each node in the K nodes based on the target quantum state of the K nodes in the node route diagram, to obtain a first target numerical measurement result of the plurality of first variables.

According to a second aspect of the present disclosure, a function processing device is provided, including:

an obtaining module, configured to obtain a first polynomial function including a plurality of terms consisting of a plurality of first variables;

a constructing module, configured to construct a node route diagram of a quantum approximate optimization algorithm (QAOA) based on the first polynomial function, where the node route diagram includes K nodes, K is determined based on the first polynomial function, and K is an integer greater than 1;

a generating module, configured to generate quantum entangled states of the node route diagram, where the quantum entangled states include target quantum states of the K nodes in the node route diagram; and

a numerical measuring module, configured to sequentially perform a numerical measurement on each node in the K nodes based on the target quantum state of the K nodes in the node route diagram, to obtain a first target numerical measurement result of the plurality of first variables.

According to a third aspect of the present disclosure, an electronic device is provided, including:

at least one processor; and

a memory communicatively coupled to the at least one processor; where

the memory stores instructions executable by the at least one processor to enable the at least one processor to perform the method in the first aspect.

According to a fourth aspect of the present disclosure, a non-transitory computer readable storage medium is provided, having stored thereon computer instructions for enabling the computer to perform the method in the first aspect.

According to a fifth aspect of the present disclosure, a computer program product is provided, including a computer program, where the computer program is executed by a processor to perform the method in the first aspect.

According to the technology of the application, the problem that the QAOA algorithm has poor evolution effect when the polynomial combination optimization is solved, and the evolution effect of the QAOA algorithm is improved, so that the effect of the polynomial combination optimization solving is improved.

It should be understood that the statements in this section are not intended to identify key or critical features of the embodiments of the present disclosure, nor are they intended to limit the scope of the present disclosure. Other features of the present disclosure will become apparent from the following description.

### BRIEF DESCRIPTION OF THE DRAWINGS

The drawings are included to provide a better understanding of the present solution and are not to be considered limiting of the present disclosure. Where:

FIG. 1 is a flow chart diagram of a function processing method according to a first embodiment of the present disclosure;

FIG. 2 is a schematic structural diagram of a node graph;

FIG. 3 is a schematic diagram of the structure of a QAOA diagram;

FIG. 4 is a diagram illustrating a structure of a function processing device according to a second embodiment of the present disclosure; and

FIG. 5 illustrates a schematic block diagram of an example electronic device 500 that can be used to implement embodiments of the present disclosure.

### DETAILED DESCRIPTION

The following description of the exemplary embodiments of the present disclosure, taken in conjunction with the accompanying drawings, includes various details of the embodiments of the present disclosure to assist in understanding, which are to be considered exemplary only. Accordingly, those of ordinary skill in the art will recognize that various changes and modifications of the embodiments described herein can be made without departing from the scope and spirit of the present disclosure. Also, descriptions of well-known functions and constructions are omitted in the following description for clarity and conciseness.

### First Embodiment

As shown in FIG. 1, the present disclosure provides a function processing method, including the following steps:

Step S101: obtaining a first polynomial function including a plurality of terms consisting of a plurality of first variables.

In the embodiment, the function processing method relates to the technical field of quantum computation, in particular to the field of evolutionary computation in quantum computation, and can be widely applied to numerous fields such as statistical physics, image processing, network design, super large scale integrated circuit design, data clustering analysis, signal processing, image reconstruction in computer vision and the like.

In actual use, the function processing method according to the embodiment of the present disclosure may be executed by the function processing device according to the embodiment of the present disclosure. The function processing device in the embodiment of the present disclosure may be configured in any electronic device to execute the function processing method in the embodiment of the present disclosure. The electronic device may be a server or a terminal, and is not limited specifically here.

The first polynomial function may be a polynomial function, and the polynomial function refers to an algebraic form consisting of the addition of a number of monomials (one number less equal to the opposite number to which it was added if there was a subtraction), each monomial in the polynomial function being called a term of the polynomial. That is, the first polynomial function may include a plurality of terms, the plurality of terms being composed of a plurality of first variables, each term including at least one first variable.

The first polynomial function may be represented by the following formula (1):

$$c ( x ) = {\sum }_{s ⊆ [ Q ]} {c}_{S} ( x )$$

cₛ (x) may be referred to as a first polynomial function, expressed as

$${c}_{S} ( x ) = {α}_{S} {\prod }_{j ∈ S} {x}_{j} ,$$

and x=(x₁,x₂, . . . , x_{Q})∈{0,1}^{Q} may be referred to as a variable set, where a plurality of first variables may be included, and a value thereof is bit sequence with a length of Q, and each first variable may take a value of 0 or 1, and a coefficient αₛ may be a real numbers, [Q]={1,2, . . . , Q} and S is a subset of [Q].

The operation of the first polynomial function may be performed in accordance with a polynomial combinatorial optimization problem. The polynomial combination optimization problem is specifically described as follows: given a polynomial function as shown in equation (1), the variables in the polynomial function are solved so that the function value of the polynomial function is maximized as shown in equation (2).

$${max}_{x ∈ {\{ 0 , 1 \}}^{Q}} c ( x )$$

The first polynomial function may be obtained in various manners, for example, a function construction parameter input by a user is received, and the first polynomial function is automatically generated, where the function construction parameter may include a variable number, a term number, and a function construction manner. The polynomial function stored in advance by the function processing device may be acquired as the first polynomial function, or the first polynomial function transmitted by another electronic device may be received.

Step 102: constructing a node route diagram of a quantum approximate optimization algorithm (QAOA) based on the first polynomial function, where the node route diagram includes K nodes, K is determined based on the first polynomial function, and K is an integer greater than 1.

In this embodiment, a QAOA algorithm, which is a quantum algorithm proposed by Edward Farhi et al through the idea of mixed iteration of classical computation and quantum computation, may be used to solve the polynomial combination optimization problem, and may be run on a quantum computing device.

When the QAOA algorithm evolves, a node route diagram of the QAOA needs to be constructed first, where the node route diagram refers to a spatial graph composed of K nodes and undirected edges connecting the K nodes, and may include a plurality of layers, each of which may be constructed based on a first polynomial function.

In short, if the node-line graph is regarded as an overall system, the node-line graph may include a plurality of subsystems, each layer in the node-line graph may be regarded as a subsystem, and each subsystem may be generated based on the first polynomial function.

The node route diagram of the QAOA may be constructed based on the first polynomial function, where each layer in the node route diagram of the QAOA may be the same or different, and is not limited herein.

The node route diagram of the QAOA may be directly constructed based on the first polynomial function, or may be indirectly constructed based on the first polynomial function, which is not particularly limited herein.

In an optional embodiment, each layer in the node route diagram may be indirectly constructed based on a first polynomial function, and specifically, may be based on a preset variable relationship, perform variable replacement processing on a first variable of the first polynomial function to obtain a second polynomial function, and then construct the node graph based on the second polynomial function, where a variable in the second polynomial function may be referred to as a second variable.

In an alternative embodiment, the construction may include constructing a node graph based on the first polynomial function, the node graph comprising M nodes, M determined based on the first polynomial function, and repeatedly stacking the node graphs in parallel in sequence to form a node route diagram of the QAOA, where the K nodes comprise the M nodes, and K is an integer greater than or equal to M.

Namely, a subsystem is constructed based on the first polynomial function, and then a large system is stacked based on the subsystem, where the large system is the node route diagram of the QAOA.

The node route diagram of the QAOA constructed in a different manner may be constructed in another manner, and the construction of the node route diagram is not limited to this.

K is determined based on the first polynomial function. In an optional embodiment, the number of nodes in each layer of the node-line graph may be the same, and the nodes are M nodes, that is, K is a multiple of M, and M may be determined based on the first polynomial function, which may be described in detail in the following embodiment.

It should be noted that M may be directly determined based on the first polynomial function in the case where the node graph is directly constructed based on the first polynomial function, and M is indirectly determined based on the first polynomial function in the case where the node graph is indirectly constructed based on the first polynomial function. Specifically, the node graph in the node route diagram may be indirectly constructed based on a first polynomial function, and may be constructed based on a preset variable relationship by performing variable replacement processing on a first variable of the first polynomial function to obtain a second polynomial function, and then constructing the node graph based on the second polynomial function, where a variable in the second polynomial function may be referred to as a second variable, and M may be determined based on the number of the second variable and the number of items, including at least two second variables, in a plurality of terms composed of a plurality of second variables.

Step S103: generating quantum entangled states of the node route diagram, where the quantum entangled states include target quantum states of the K nodes in the node route diagram.

In this step, the quantum entangled state refers to a physical state describing the whole system of the node route diagram, which may be a vector such as a column vector, including the target quantum states of the K nodes in the node route diagram, and each node may have a target quantum state in the node route diagram, and the target quantum state of each node in the node route diagram may be characterized by a quantum state of a qubit. In quantum physics, a quantum state refers to a state describing an isolated system and contains all information of the system, that is, a quantum entangled state includes quantum states of all nodes of a node route diagram in the node route diagram, i.e., the whole system.

The quantum entangled state of the node route diagram may be generated in various ways, and in an optional embodiment, the generating the quantum entangled state of the node route diagram includes:

generating a quantum state for each of the K nodes;

performing tensor product operation based on the quantum state of each node in the K nodes to obtain a first operation result;

performing tensor product and matrix multiplication operations on the T pieces of control information to obtain a second operation result, where T is determined based on the number of the undirected edges included in the node route diagram, and the control information is information corresponding to the control Z gate; and

performing multiplication operation on the first operation result and the second operation result to obtain a quantum entangled state of the node route diagram.

In this embodiment, the quantum entangled state of the node route diagram can be constructed in the function processing device based on the structure of the node route diagram, so that the evolution of the QAOA algorithm can be realized locally.

In another alternative embodiment, the generating the quantum entangled state of the node route diagram includes obtaining a quantum resource state corresponding to the node route diagram, and cutting the quantum resource state based on the node route diagram to obtain the quantum entangled state of the node route diagram.

In this embodiment, the function processing device may request, based on the node route diagram of the constructed QAOA, a quantum resource state of an appropriate size from another electronic device, such as a cloud-end quantum server, where the quantum resource state refers to a general quantum entangled state of the system, which may be a cluster state or other general quantum resource state, to obtain a general quantum resource state corresponding to the node route diagram. And then, cutting the quantum resource state according to the structure of the node route diagram of the constructed QAOA to obtain the quantum entangled state of the node route diagram.

Since the requested quantum resource state is a general quantum state unrelated to the QAOA algorithm, another electronic device such as a cloud-side quantum server cannot know what data is used and what algorithm is executed, so that privacy and computational security of a user can be protected when the QAOA algorithm evolves.

Step 104: sequentially performing a numerical measurement on each node in the K nodes based on the target quantum state of the K nodes in the node route diagram, to obtain a first target numerical measurement result of the plurality of first variables.

QAOA algorithms typically evolve within the framework of quantum circuit models to solve polynomial combinatorial optimization problems. However, because the quantum bit coherence time of the quantum circuit model in physical experiments is very short, the quantum algorithm designed based on the quantum circuit model is limited by the coherence time, so that the number of layers of the quantum circuit cannot be too deep.

Therefore, as the quantum gate operation is required to be sequentially carried out on the quantum states in order when the QAOA algorithm is evolved, the algorithm evolution is limited by the coherence time, so that the deep quantum circuit cannot be adopted to achieve the required algorithm evolution effect in the aspect of physical realization, and the evolution effect of the QAOA algorithm is poor.

In this step, for the quantum entangled state of the prepared node route diagram of the QAOA, each node in the K nodes may be sequentially measured in a single qubit measurement manner to obtain a first target numerical measurement result of the plurality of first variables.

Specifically, each node in the K nodes may be sequentially subjected to numerical measurement based on a target quantum state of the K nodes in the node route diagram to obtain a numerical measurement result of the K nodes, and then a first target numerical measurement result of the plurality of first variables may be determined based on the numerical measurement result of the K nodes.

For example, if the node route diagram includes 30 nodes, the quantum entangled state includes 30 qubit quantum states, and the node corresponding to the qubit quantum state may be measured numerically for the qubit quantum state in turn, so as to obtain a numerical measurement result of the node, and finally obtain a numerical measurement result of the 30 nodes.

In the process of numerical measurement, the numerical measurement results have a dependency relationship. In other words, the numerical measurement results of the nodes which are sequentially arranged and carry out numerical measurement later may depend on the numerical measurement results of the nodes which are subjected to numerical measurement earlier, so that when the numerical measurement is carried out, the nodes in the node route diagram need to be sequentially subjected to numerical measurement according to a preset sequence, and the preset sequence is explained in detail in the following implementation modes.

Moreover, since the first target numerical measurement result of the first variable depends on the numerical measurement result of the last node of the K nodes to perform numerical measurement, the first target numerical measurement results of the plurality of first variables may be determined based on the numerical measurement results of the K nodes after the numerical measurement results of the K nodes are determined. The specific process of determining the first target numerical measurement of the plurality of first variables based on the numerical measurements of the K nodes is described in detail in the following embodiments.

The numerical measurement result of each first variable in the plurality of first variables can have two conditions, each condition can represent the value of the first variable, the first condition can be represented by a value 0 and represents that the value of the first variable is 0, and the second condition can be represented by 1 and represents that the value of the first variable is 1.

That is, the first target numerical measurement result of the plurality of first variables may be a bit string, which is expressed by o, a number of bits is equal to the number of the first variables, for example, when the number of the first variables is 4, o may be a 01 string of 4 bits, where each character in the 01 string represents a value corresponding to the first variable.

For example, the first target numerical measurement result o of the plurality of first variables is “0101”, and the first target numerical measurement result may represent, in order from left to right, the numerical of the first variable x₁, first variable x₂, first variable x₃ and first variable x₄.

The target measurement operation may be performed once, and a measurement result obtained by performing once may be determined as a first target numerical measurement result of the plurality of first variables. And performing a target measurement operation on each node in the K nodes in sequence based on the target quantum states of the K nodes in the node route diagram.

The target measuring operation may be performed multiple times, and a final first target numerical measurement result of the multiple variables may be determined based on multiple measurement results obtained by performing multiple times, which is not specifically limited herein.

In practical applications, due to the randomness of the numerical measurement, N times of target measurement operations may be performed to obtain N second target numerical measurement results of the plurality of first variables, where N is a positive integer generally greater than 1, and the first target numerical measurement result of the plurality of variables may be determined based on the N second target numerical measurement results, and specifically, a measurement result with a highest occurrence frequency among the N second target numerical measurement results may be determined as the first target numerical measurement result of the plurality of variables.

For example, if the bit string “0101” appears most frequently in the N second target numerical measurements, the first target numerical measurement of the plurality of variables is “0101”.

In addition, the measurement mode in the numerical measurement process is determined based on the angle information, the angle information is different, the measurement mode is also different, and the finally obtained numerical measurement result is also different, so that the target measurement operation can be executed for N times to determine the numerical measurement score condition under the measurement mode of the angle information, the angle information is updated based on the numerical measurement score condition, and the numerical measurement is repeatedly performed based on the updated angle information, so that the purpose of improving the accuracy of the numerical measurement result and improving the function operation effect is finally achieved.

Thereafter, after obtaining a first target numerical measurement of the plurality of first variables, a combined output of the first polynomial function may be determined based on the first target numerical measurement. Specifically, a value of each first variable in the first target numerical measurement result may be substituted into the first polynomial function, so as to obtain a combined output result of the first polynomial function.

In this embodiment, by obtaining a first polynomial function, the first polynomial function includes a plurality of terms composed of a plurality of first variables; constructing a node route diagram of a quantum approximate optimization algorithm (QAOA) based on the first polynomial function, where the node route diagram comprises K nodes, and K is determined based on the first polynomial function; generating quantum entangled states of the node route diagram, the quantum entangled states including target quantum states of the K nodes in the node route diagram; and sequentially performing numerical measurement on each node in the K nodes based on the target quantum state of the K nodes in the node route diagram to obtain a first target numerical measurement result of the plurality of first variables. Therefore, the quantum entangled state of the QAOA generated based on the first polynomial function can be used for measuring a single quantum bit so as to sequentially measure each node, and a plurality of nodes can be simultaneously measured, so that the quantum gate operation on the quantum state sequentially can be avoided when algorithm evolution is carried out, the limitation on the coherence time can be reduced, the evolution effect of the QAOA algorithm is improved, and the effect of polynomial combination optimization solution can be improved.

In addition, the evolution mode of the QAOA algorithm for solving the polynomial combination optimization problem in this embodiment is easier to implement on hardware platforms such as ion traps and quantum optics.

Optionally, the step S102 specifically includes:

constructing node graphs based on the first polynomial function, where the node graphs include M nodes, and the M is determined based on the first polynomial function;

repeatedly stacking the node graphs in parallel and sequentially, to form a node route diagram of the QAOA, where the K nodes include the M nodes, and K is an integer greater than or equal to M.

In the present embodiment, since the node line diagram of the QAOA may be referred to as a QAOA diagram and each layer of the QAOA diagram is the same, when constructing the QAOA diagram, it is only necessary to construct one layer of the QAOA diagram, which may be referred to as a single-layer QAOA diagram, and then, the single-layer QAOA diagram may be obtained by repeatedly stacking the QAOA diagrams.

A node graph, i.e., a single-layer QAOA map, may be constructed based on a first polynomial function, the node graph may include M nodes, K is a multiple of M, and M may be directly or indirectly determined based on the first polynomial function, and the construction thereof will be described in detail in the following embodiments.

In the present embodiment, a single-layer QAOA map is constructed based on the first polynomial function, and the node graphs are repeatedly stacked in parallel in sequence to construct a node line map of the QAOA.

Optionally, the constructing a node graph based on the first polynomial function includes:

performing, based on a preset variable relation, a variable replacement processing on a first variable in the first polynomial function, to obtain a second polynomial function, where the second polynomial function includes a plurality of terms consisting of a plurality of second variables, and the second variables and the first variables meet the preset variable relation;

creating Q first nodes and Q second nodes, where the Q first nodes are in a one-to-one correspondence with the Q second nodes, the Q second nodes are in a one-to-one correspondence with the plurality of second variables, and Q is an integer greater than 1; and

constructing the node graphs based on the Q first nodes and the Q second nodes, where the node graphs include the Q first nodes which are sequentially and longitudinally arranged, the Q second nodes which are sequentially and longitudinally arranged, and undirected edges which connect the first nodes and the second nodes which are arranged side by side, and the M nodes include the Q first nodes and the Q second nodes.

In the construction process of the single-layer QAOA map defined in the present embodiment, first, a first variable in the first polynomial function may be subjected to variable replacement processing based on a preset variable relationship, so as to obtain a second polynomial function, where in the preset variable relationship, relationships between different variables may be in an inverse relationship.

In an optional implementation manner, the preset variable relationship may be that, if the first variable is the first variable and the second variable is the second variable, the first variable in the first polynomial function may be replaced by the second variable based on the preset variable relationship to obtain the second polynomial function. The second variables and the first variables meet the preset variable relation, and the number of the first variables is equal to that of the second variables. In addition, the number of terms included in the second polynomial function is determined comprehensively based on the terms included in the first polynomial function, the number of first variables, and the preset variable relationship.

The second polynomial function c(z)=Σ_{s⊆[Q]} cₛ(z) is obtained by sorting, where

$${c}_{S} ( z ) = {η}_{S} {\prod }_{j ∈ S} {z}_{j} ,$$

the second variable z=(z₁, z₂, . . . , zₙ)∈{−1,1}^{Q}.

For example, the first polynomial function is (x)=2x₁+4x₁x₂, if the predetermined variable relationship is x=(1−z)/2, the second polynomial function is (x)=−2z₁−z₂+z₁z₂+2.

Thereafter, a node graph may be constructed based on the second polynomial function. Specifically, Q first nodes and Q second nodes may be created, where Q is equal to the number of second variables, the Q first nodes correspond to the Q second nodes one to one, and the Q second nodes also correspond to the plurality of second variables one to one.

Where the first node may be represented as G^{k} and the second node may be represented as B^{k}, k∈[Q].

The node graph may be constructed based on Q first nodes and Q second nodes, specifically, the Q first nodes may be sequentially and longitudinally arranged, the Q second nodes are sequentially and longitudinally arranged, and the first nodes and the second nodes that are arranged side by side are connected by using an undirected edge, that is, the first nodes G^{k} and the second nodes B^{k} are connected.

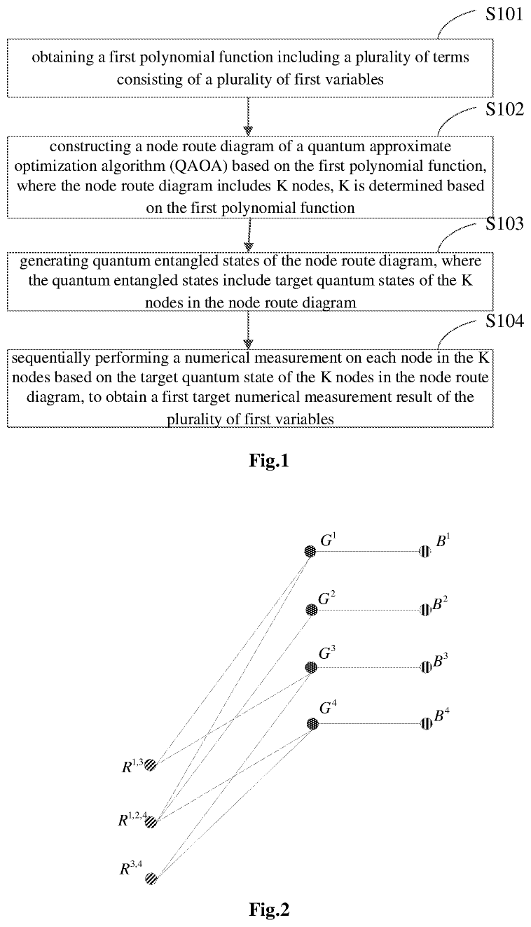

Referring to FIG. 2, FIG. 2 is a schematic structural diagram of a node graph, as shown in FIG. 2, the node graph is constructed based on a second polynomial function c(z)=z₂ z₁z₃+5z₃z₄−2z₁z₂z₄, and since the number of variables is 4, the number of created first nodes and second nodes is 4, and the 4 first nodes are sequentially arranged longitudinally, the 4 second nodes are sequentially arranged longitudinally, and the first nodes and the second nodes that are arranged side by side are connected by using undirected edges.

In this way, the construction of the node graph, and thus the construction of the QAOA map, can be achieved based on the first polynomial function.

Optionally, in a case that the plurality of terms composed of the plurality of second variables includes items of at least two second variables, before the constructing the node graph based on the Q first nodes and the Q second nodes, the method further includes:

creating L third nodes, where the L third nodes are in a one-to-one correspondence with items including at least two second variables in the plurality of terms consisting of the second variables, and L is a positive integer;

for each third node in the L third nodes, respectively connecting the third node with at least two target nodes to obtain undirected edges between the third node and the at least two target nodes, where the target node is the first node in the Q first nodes, which corresponds to a second variable in a term corresponding to the third node;

where the node graphs further include the L third nodes and undirected edges between the L third nodes and the target node, and the M nodes further include the L third nodes.

In this embodiment, for each set S in the second polynomial function, that is, for each of the plurality of terms consisting of the plurality of second variables, if the number of the second variables included is |S|≥2, and η_{S}≠0, a third node is added to the left of the first node, and the third node is marked as R^{S} and is connected to the first node corresponding to the second variable in the Q first nodes, respectively.

As shown in FIG. 2, since the plurality of terms of the second polynomial function includes at least two terms of the second variable as 3, 3 third nodes may be created, and for each third node, the third node is connected to the corresponding first node through a undirected edge.

For example, for a third node R^{1, 3}, the third node may be connected to the 1 st first node and the 3 rd first node through a undirected edge.

In this embodiment, in a case where the plurality of terms made up of the plurality of second variables include items of at least two second variables, by creating L third nodes that are in one-to-one correspondence with the items of the plurality of terms made up of the plurality of second variables, which include at least two second variables; for each third node in the L third nodes, respectively connecting the third node with at least two target nodes to obtain a undirected edge between the third node and the at least two target nodes, where the target node is a first node in the Q first nodes, which corresponds to a second variable in a term corresponding to the third node; where the node graph further includes the L third nodes and undirected edges between the L third nodes and a target node. In this way, the construction of the node graph can be further realized based on the first polynomial function, and the construction of the QAOA map can be realized, so that the constructed QAOA map is more accurate.

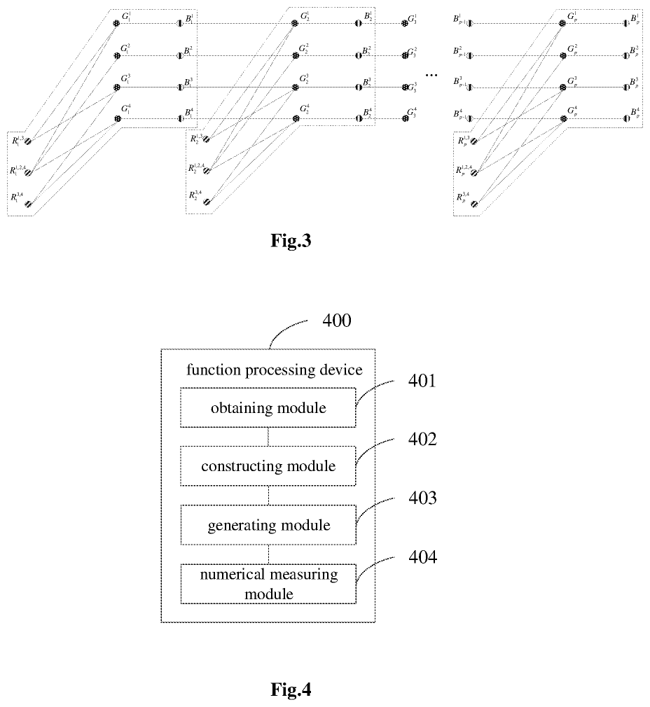

After the node graph is constructed, because the QAOA algorithm repeatedly and alternately evolves the initial quantum state for a plurality of times, correspondingly, the single-layer QAOA graph obtained by construction can be repeated for a plurality of times and sequentially arranged to form a new graph, which is called a QAOA graph. Specifically, referring to FIG. 3, FIG. 3 is a schematic diagram of the structure of the QAOA map, and as shown in FIG. 3, given a positive integer p, the corresponding QAOA map is constructed as follows:

the single-layer QAOA map is repeated p times and arranged in parallel in sequence, and in order to distinguish elements on each copy, a kth copy of the single-layer QAOA map may be denoted by subscripts, and in parallel, a third node, a first node, and a second node on the kth copy may be denoted Rₖ^{S}Gₖ^{v}, Bₖ^{v}, respectively.

Meanwhile, a second node Bₖ^{v} and a first node Gₖ₊₁^{v} in the next copy are connected between the adjacent copies, where v∈[Q], k∈{1, . . . , p−1}, the generated QAOA map is QAOA(c,p) representing a first polynomial function, and the QAOA map includes an image layer.

Optionally, the step S104 specifically includes:

sequentially performing, based on the target quantum states of the K nodes in the node route diagram, the numerical measurement on each node in the node route diagram according to a stacking sequence of the node graphs in the node route diagram to obtain the numerical measurement result of the K nodes;

determining a first target numerical measurement result of the plurality of first variables based on the numerical measurement result of the K nodes.

In this embodiment, when performing numerical measurement, it is necessary to sequentially perform numerical measurement on the nodes in the node graph according to a preset sequence, where the preset sequence may include a stacking sequence of the node graph in the node graph, so as to sequentially perform numerical measurement on each node in the node graph according to the stacking sequence of the node graph in the node graph.

Specifically, the numerical of each node in the 1 st node graph may be measured, and after the measurement is completed, the numerical of each node in the 2 nd node graph may be measured, and so on, and finally the numerical of each node in the last node graph, that is, the p-th node graph may be measured until the numerical measurement results of the K nodes are obtained.

In the numerical measurement process, the numerical measurement result of the node in the node graph measured later may depend on the numerical measurement result of the node in the node graph measured earlier, and the dependency relationship thereof will be described in detail in the following embodiments.

In this way, each node in the node graph is sequentially subjected to numerical measurement according to the stacking sequence of the node graph in the node graph, so that the numerical measurement of each node in the node graph can be realized, and the numerical measurement results of the K nodes are obtained. A first target numerical measurement of the plurality of first variables is then determined based on the numerical measurements of the K nodes.

Optionally, the obtaining a numerical measurement result of the K nodes by sequentially measuring each node in the node graph based on the target quantum state of the K nodes in the node graph, includes:

for each third node in the first node graph, performing the numerical measurement on the third node in a first target measurement mode based on the target quantum state of the third node in the node route diagram to obtain a numerical measurement result of the third node in the first node graph, where the first target measurement mode is a measurement mode in which a measurement angle in the first measurement mode is determined based on a numerical measurement result of a second node in a second node graph corresponding to the third node, a coefficient in a term corresponding to the third node, and first angle information, and the second node graph is a node graph stacked before the first node graph;

for each first node in the first node graph, performing the numerical measurement on the first node in a second target measurement mode based on a target quantum state of the first node in the node route diagram to obtain a numerical measurement result of the first node in the first node graph, where the second target measurement mode is a measurement mode in which a measurement angle in the second measurement mode is determined based on a numerical measurement result of a second node corresponding to the first node in the second node graph, a coefficient in a term of a second variable corresponding to the first node, and first angle information; and

for each second node in the first node graph, performing numerical measurement on the second node in a third target measurement mode based on a target quantum state of the second node in the node route diagram to obtain a numerical measurement result of the second node in the first node graph, where the third target measurement mode is a measurement mode in which a measurement angle in the second measurement mode is determined based on a numerical measurement result of a third node related to a second variable corresponding to the second node in a third node graph, a numerical measurement result of a first node corresponding to the second node in the third node graph and second angle information, and the third node graph includes the first node graph and the second node graph.

In this embodiment, after the quantum entangled state of the QAOA map is generated, a single-bit measurement scheme, which will be described in detail below, may be employed to numerically measure each node in the node wiring map based on the quantum entangled state.

In the single-bit measurement scheme, two measurement modes are mainly included, namely a first measurement mode and a second measurement mode, where each measurement mode is given by a pair of orthogonal vectors with parameters, and the parameters can be measurement angle parameters.

The first measurement mode may be expressed as: [symbol] ^{x} (θ)={R^{x}(θ)|0 [symbol] , R^{x}(θ)|1 [symbol] }, the second measurement mode can be expressed as [symbol] ^{z}(θ)={R^{z}(θ)|+ [symbol] , R^{z}− [symbol] }, θ is measurement angle parameters, and

$$\vert 0 〉 = [ \begin{matrix}1 \\ 0\end{matrix} ] and \vert 1 〉 = [ \begin{matrix}0 \\ 1\end{matrix} ]$$

are calculating basis, and |+ [symbol] =(|0 [symbol] +|1 [symbol] )/\sqrt{2}, |− [symbol] =(|0 [symbol] −|1 [symbol] )/\sqrt{2}, R^{x}(θ)=e^{-iθX/2} is a single-bit turnstile around the x-axis, R^{z}(θ)=e^{-iθZ/2} is a single-bit turnstile around the z-axis,

$$X = [ \begin{matrix}0 & 1 \\ 1 & 0\end{matrix} ] , Z = [ \begin{matrix}1 & 0 \\ 0 & - 1\end{matrix} ] .$$

Specifically, the input angle information includes first angle information and second angle information, the first angle information is a vector γ=(γ₁, . . . , γₚ), and the second angle information is a vector β=(β₁, . . . , βₚ).

Firstly, performing numerical measurement on nodes in each layer in sequence according to the stacking sequence of the QAOA map, and based on each layer of the QAOA map, numerically measuring quantum bits on each third node aiming at a target quantum state of each third node on the first node graph, where the measurement mode is a first target measurement mode, the first target measurement mode is a measurement mode determined by a measurement angle in the first measurement mode based on a numerical measurement result of a second node corresponding to the third node in the second node graph, a coefficient in a term corresponding to the third node and first angle information, and the measurement angle is represented by the following formula (3).

$$γ ( {R}_{l}^{S} ) = {( - 1 )}^{1 + {\sum }_{v ∈ S} {\sum }_{k = 1}^{l - 1} s ( {B}_{k}^{v} )} 2 {γ}_{l} {η}_{S}$$

And the sequence number of the image layer is represented, summation Σₖ₌₁⁰(.)=0 is defined, s(Bₖ^{v}) is the numerical measurement result of a second node corresponding to the third node in a second node graph, ηₛ is the coefficient in the corresponding item of the third node, and the numerical measurement result of each third node is recorded as s(Rₗ^{s}).

For a target quantum state of each first node on the first node graph, numerically measuring a qubit on each first node in a second target measurement mode, where the second target measurement mode is a measurement mode in which a measurement angle in the second measurement mode is determined based on a numerical measurement result of a second node corresponding to the first node in the second node graph, a coefficient in a term of a second variable corresponding to the first node, and first angle information, and the measurement angle is represented by the following equation (4).

$$γ ( {G}_{l}^{v} ) = {( - 1 )}^{1 + {\sum }_{k = 1}^{l - 1} x ( {B}_{k}^{v} )} 2 {γ}_{l} {η}_{v}$$

s(Bₖ^{v}) is the numerical measurement result of a second node corresponding to the first node in a second node graph, and the ηᵥ in the term of the second variable corresponding to the first node, recording the numerical measurement result s(Gₗ^{v}) of each first node.

For the target quantum state of each second node Bₗ^{v} on the first node graph, the quantum bit on each second node is measured numerically, the measurement mode is a third target measurement mode, the measurement angle in the second measurement mode is determined based on the numerical measurement result of a third node related to a second variable corresponding to the second node in a third node graph, the numerical measurement result of a first node corresponding to the second node in the third node graph, and the second angle information, and the measurement angle is represented by the following formula (5).

$$β ( {B}_{l}^{v} ) = {( - 1 )}^{1 + {\sum }_{k = 1}^{l} s ( {R}_{k} , v ) + {\sum }_{k = 1}^{l} s ( {G}_{k}^{v} )} 2 {β}_{l}$$

s(Rₖ,v)=Σ_{SεN}_{_{ϵ}}₍ᵥ₎s(Rₖ^{S}) represents a numerical measurement results of the third node related to the second variable corresponding to the second node in the third node graph, e.g.,

if the result is 3, s(Rₖ,v) represents the sum of the numerical measurement results of the third nodes Rₖ^{1,3} and Rₖ^{3,4}, and s(Gₖ^{v}) is the numerical measurement result of the first node corresponding to the second node in the third node graph, recording the numerical measurement result s(Bₖ^{v}) of each second node.

Therefore, the numerical measurement results of the K nodes can be measured, the first target numerical measurement results of the first variables are determined based on the obtained numerical measurement results of the K nodes, the numerical measurement of the first variables can be realized by adopting a single-bit measurement scheme, and then a user only needs to be provided with a single-bit measurement device, so that the function operation can be realized, and the measurement device is greatly simplified.

Optionally, the determining a first target numerical measurement of the plurality of first variables based on the numerical measurements of the K nodes includes:

for each first variable in the plurality of first variables, summing the numerical measurement results of a second node corresponding to a target variable in a node graph of the node route diagram to obtain a target value corresponding to the first variable; and performing modular operation on the target value to obtain a first target numerical measurement result of the first variable, where the target variable is a second variable which has the preset variable relation with the first variable.

In this embodiment, for each of the plurality of first variables, a first target numerical measurement thereof may be determined using equation (6) below.

o(v)=ₖ₌ₗ^{p}s(Bₖ^{v})mod 2 ∀v∈[Q]

o(v) represents a first target numerical measurement result of the first variable v, s(Bₖ^{v}) represents a numerical measurement result of the second node corresponding to the first variable v in the node graph, summing the numerical measurement results of the second nodes corresponding to the first variables v in all the node graphs to obtain target values corresponding to the first variables, and performing modulo-2 operation on the target values to finally obtain first target numerical measurement results of the first variables v.

Each first variable is similarly determined to have a first target numerical measurement, and ultimately a first target numerical measurement of the plurality of variables, where o=(o(1), . . . , o(Q)). In this way, a numerical measurement may be performed on each of the K nodes, so as to determine a first target numerical measurement result of the plurality of first variables.

Optionally, the step S104 specifically includes:

executing target measurement operation N times to obtain N second target numerical measurement results of the plurality of first variables, where N is a positive integer, and the target measurement operation is: sequentially performing the numerical measurement on each node in the K nodes based on the target quantum state of the K nodes in the node route diagram;

determining a first target function value based on the N second target numerical measurement results, where the first target function value is used for representing numerical measurement score conditions of the plurality of first variables in N times of executing target measurement operation;

updating angle information in the target measurement operation based on the first target function value, where the angle information is configured to determine a measurement angle for performing numerical measurement on each node in the K nodes in the target measurement operation;

performing the target measurement operation N times again based on the updated angle information to determine a second target function value; and

determining a measurement result with the highest occurrence frequency in the N second target numerical measurement results as a first target numerical measurement result of the plurality of first variables when a difference between the first target function value and the second target function is smaller than a preset threshold value.

In this embodiment, due to the randomness of the numerical measurement, the target measurement operation may be performed N times to obtain N second target numerical measurements of the plurality of first variables.

In addition, because the measurement mode in the numerical measurement process is determined based on the angle information, and the angle information is different, the measurement mode is also different, and the finally obtained numerical measurement result is also different, the target measurement operation can be executed for N times to determine the numerical measurement score condition under the measurement mode of the angle information, the angle information is updated based on the numerical measurement score condition, and the numerical measurement is repeatedly performed based on the updated angle information, so that the purpose of improving the accuracy of the numerical measurement result and improving the function operation effect is finally achieved.

Specifically, the algorithm of the single-bit measurement scheme, i.e., the target measurement operation, may be performed N times, and the second target numerical measurement result, which is output each time, is recorded, respectively denoted. The target measurement operation may use the single-bit measurement scheme of the above embodiment to perform numerical measurement.

Counting the value distribution of the N second target numerical measurement results and the frequency of each value distribution, where the frequency is expressed by p_{γ,β}(x):=|{i:oᵢ=x}|1/N. And calculating a first target function value by using the target function cₚ(γ,β)=Σ_{x∈{0,1}}_{^{Q}}c(x)p_{γ,β}(x).

Then, the sum, i.e. the value of the angle information, is optimized and updated by a classical optimizer based on the first target function value.

And based on the updated angle information, namely the first angle information and the second angle information in the target measurement operation, executing the target measurement operation for N times again, namely, circulating the steps to obtain a second target function value until the difference between the first target function value and the second target function value obtained twice continuously is smaller than a preset threshold value, stopping running at the moment, determining the measurement result with the highest occurrence frequency in the N second target numerical measurement results as the first target numerical measurement result of the plurality of first variables, and outputting the first target numerical measurement result x*=arg maxₓ p_{γ,β}(x). The preset threshold may be set according to actual conditions, and may be a parameter input in advance.

For example, the bit string “0101” appears most frequently in the N second target numerical measurements, and the first target numerical measurement of the plurality of first variables may be the bit string “0101”.

Optionally, the step S103 specifically includes:

generating a quantum state for each of the K nodes;

performing a tensor product operation based on the quantum state of each node in the K nodes to obtain a first operation result;

performing tensor product and matrix multiplication operations on the T pieces of control information to obtain a second operation result, where T is determined based on the number of the undirected edges included in the node route diagram, and the control information is information corresponding to the control Z gate; and

performing a multiplication operation on the first operation result and the second operation result to obtain a quantum entangled state of the node route diagram.

The present embodiment describes a process in which the function processing device constructs a quantum entangled state of the QAOA map based on the QAOA map, and the quantum entangled state of the QAOA map may be referred to as a state of the QAOA map.

Specifically, for a QAOA diagram, a quantum state of each node in the K nodes may be generated, where the quantum state is a physical state of the node on a corresponding layer, that is, a subsystem. A quantum state |+ [symbol] =(|0 [symbol] +|1 [symbol] )/\sqrt{2} may be provided. If an undirected edge is connected between the two nodes, a control Z gate is acted on the quantum state corresponding to the two nodes, the control information CZ=|0 [symbol] [symbol] 0|⊗I+|1 [symbol] [symbol] |⊗Z of the control Z gate is controlled, and

$$I = [ \begin{matrix}1 & 0 \\ 0 & 1\end{matrix} ] and Z = [ \begin{matrix}1 & 0 \\ 0 & - 1\end{matrix} ]$$

are Pauli matrixes.

The action of the control Z gate on the quantum states corresponding to the two nodes means that tensor product operation is carried out on the quantum states of the two nodes, and then matrix multiplication operation is carried out on the quantum states and control information corresponding to the control Z gate to obtain output.

Because the control Z gate is in a diagonal form and does not distinguish a control bit from a controlled bit, a plurality of control Z gates can be acted on the node route diagram at one time, and particularly tensor product operation can be carried out based on the quantum state of each node in the K nodes to obtain a first operation result; and then performing tensor product and matrix multiplication operations on the T pieces of control information to obtain a second operation result, where T is the number of undirected edges included in the node route diagram, and then performing multiplication on the first operation result and the second operation result to obtain a quantum entangled state of the node route diagram, so that the operation is shallow, and the algorithm evolution effect can be further improved.

For example, the graph G is represented as a node set and an undirected edge set, and the graph state of the graph G can be generated by the following equation (7).

$$\vert G 〉 = {\prod }_{( u , v ) ∈ E} {CZ}_{uv} {\prod }_{v ∈ V} \vert + 〉 v$$

In the same manner as in the above formula (7), a pattern corresponding to the QAOA map, represented by |QAOA(c,p) [symbol] , that is, a quantum entangled state of the QAOA can be generated.

In the present embodiment, the quantum entangled state of the node route diagram can be constructed in the function processing device based on the structure of the node route diagram, and thus the evolution of the QAOA algorithm can be locally realized.

Optionally, the step S103 specifically includes:

obtaining a quantum resource state corresponding to the node route diagram;

cutting the quantum resource state based on the node route diagram to obtain the quantum entangled state of the node route diagram.

In this embodiment, the function processing device may request, based on the node route diagram of the constructed QAOA, a quantum resource state with a suitable size from another electronic device, such as a cloud quantum server, where the quantum resource state refers to a general quantum entangled state of the system, which may be a cluster state or another general quantum resource state, to obtain a general quantum resource state corresponding to the node route diagram. And then, cutting the quantum resource state according to the structure of the node route diagram of the constructed QAOA to obtain the quantum entangled state of the node route diagram.

Since the requested quantum resource state is a general quantum state unrelated to the QAOA algorithm, another electronic device such as a cloud quantum server cannot know what data is used and what algorithm is executed, so that the QAOA algorithm can be applied to the quantum internet for security proxy calculation, and privacy and computational security of a user can be protected while the QAOA algorithm evolves.

### Second Embodiment

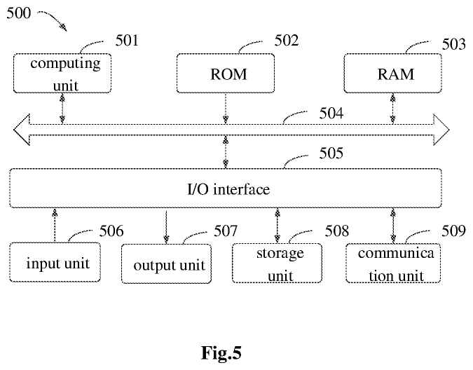

As shown in FIG. 4, the present disclosure provides a function processing device 400, comprising:

an obtaining module 401, configured to obtain a first polynomial function, where the first polynomial function includes a plurality of terms composed of a plurality of first variables;

a constructing module 402, configured to construct a node route diagram of a quantum approximate optimization algorithm QAOA based on the first polynomial function, where the node route diagram includes K nodes, K is determined based on the first polynomial function, and K is an integer greater than 1;

a generating module 403, configured to generate quantum entangled states of the node wiring diagram, where the quantum entangled states include target quantum states of the K nodes in the node wiring diagram;

a numerical measuring module 404, configured to sequentially perform numerical measurement on each node in the K nodes based on the target quantum states of the K nodes in the node route diagram, so as to obtain a first target numerical measurement result of the multiple first variables.

Optionally, where the constructing module 402 includes:

a constructing submodule configured to construct a node graph based on the first polynomial function, the node graph including M nodes, M being determined based on the first polynomial function;

the repeated stacking submodule is used for repeatedly stacking the node graphs in sequence in parallel to form a node route diagram of the QAOA, the K nodes comprise the M nodes, and K is an integer greater than or equal to M.

Optionally, the constructing submodule includes:

a variable replacement processing unit, configured to perform variable replacement processing on a first variable in the first polynomial function based on a preset variable relationship to obtain a second polynomial function, where the second polynomial function includes multiple items formed by multiple second variables, and the second variables and the first variables satisfy the preset variable relationship;

a first creating unit, configured to create Q first nodes and Q second nodes, where the Q first nodes correspond to the Q second nodes one to one, the Q second nodes correspond to the plurality of second variables one to one, and Q is an integer greater than 1;

a constructing unit, configured to construct a node graph based on the Q first nodes and the Q second nodes, where the node graph includes the Q first nodes arranged longitudinally in sequence, the Q second nodes arranged longitudinally in sequence, and a undirected edge connecting the first nodes and the second nodes arranged side by side, and the M nodes include the Q first nodes and the Q second nodes.

Optionally, in a case that the plurality of terms composed of the plurality of second variables includes terms of at least two second variables, the constructing submodule further includes:

a second creating unit, configured to create L third nodes, where the L third nodes correspond to items, including at least two second variables, in a plurality of terms formed by the plurality of second variables in a one-to-one manner, and L is a positive integer;

a constructing unit, configured to connect, for each of the L third nodes, the third node with at least two target nodes respectively to obtain a undirected edge between the third node and the at least two target nodes, where the target node is a first node, of the Q first nodes, corresponding to a second variable in a term corresponding to the third node;

where the node graph further includes the L third nodes and undirected edges between the L third nodes and a target node, and the M nodes further include the L third nodes.

Optionally, the numerical measuring module 404 includes:

the numerical measuring unit is used for sequentially performing numerical measurement on each node in the node graph according to the stacking sequence of the node graph in the node graph based on the target quantum state of the K nodes in the node graph to obtain the numerical measurement result of the K nodes;

a first determining unit configured to determine a first target numerical measurement result of the plurality of first variables based on the numerical measurement results of the K nodes.

Optionally, a node graph in the node route diagram includes a first node graph, where the first node graph is any one of the node graphs in the node route diagram, and the numerical measuring unit is specifically configured to:

for each third node in the first node graph, performing numerical measurement on the third node in a first target measurement mode based on a target quantum state of the third node in the node route diagram to obtain a numerical measurement result of the third node in the first node graph, where the first target measurement mode is a measurement mode in which a measurement angle in the first measurement mode is determined based on a numerical measurement result of a second node in a second node graph corresponding to the third node, a coefficient in a term corresponding to the third node, and first angle information, and the second node graph is a node graph stacked before the first node graph;

for each first node in the first node graph, performing numerical measurement on the first node in a second target measurement mode based on a target quantum state of the first node in the node route diagram to obtain a numerical measurement result of the first node in the first node graph, where the second target measurement mode is a measurement mode in which a measurement angle in the second measurement mode is determined based on a numerical measurement result of a second node corresponding to the first node in the second node graph, a coefficient in a term of a second variable corresponding to the first node, and first angle information;

and for each second node in the first node graph, performing numerical measurement on the second node in a third target measurement mode based on a target quantum state of the second node in the node route diagram to obtain a numerical measurement result of the second node in the first node graph, where the third target measurement mode is that a measurement angle in the second measurement mode is determined based on a numerical measurement result of a third node related to a second variable corresponding to the second node in a third node graph, a numerical measurement result of a first node corresponding to the second node in the third node graph and second angle information, and the third node graph comprises the first node graph and the second node graph.

Optionally, the first determining unit is specifically configured to:

for each first variable in the plurality of first variables, summing the numerical measurement results of a second node corresponding to a target variable in a node graph of the node route diagram to obtain a target value corresponding to the first variable; and performing modular operation on the target value to obtain a first target numerical measurement result of the first variable, wherein the target variable is a second variable which has the preset variable relation with the first variable.

Optionally, the numerical measuring module 404 includes:

a first execution unit, configured to execute a target measurement operation N times to obtain N second target numerical measurement results of the multiple first variables, where N is a positive integer, and the target measurement operation is: sequentially performing numerical measurement on each node in the K nodes based on the target quantum state of the K nodes in the node route diagram;

a second determining unit, configured to determine, based on the N second target numerical measurements, a first target function value, where the first target function value is used to characterize a numerical measurement score of the plurality of first variables in N times of execution of a target measurement operation;

an updating unit, configured to update angle information in the target measurement operation based on the first target function value, where the angle information is used to determine a measurement angle for performing numerical measurement on each node of the K nodes in the target measurement operation;

a second execution unit configured to execute the target measurement operation N times again based on the updated angle information to determine a second target function value;

a third determining unit, configured to determine, as the first target numerical measurement result of the plurality of first variables, a measurement result with a highest frequency of occurrence among the N second target numerical measurement results when a difference between the first target function value and the second objective function is smaller than a preset threshold.

Optionally, the generating module 403 includes:

a generating unit configured to generate a quantum state of each of the K nodes;

the first operation unit is used for performing tensor product operation based on the quantum state of each node in the K nodes to obtain a first operation result;

the second operation unit is used for performing tensor product and matrix multiplication operations operation on T pieces of control information to obtain a second operation result, T is determined based on the number of the undirected edges included in the node route diagram, and the control information is information corresponding to a control Z gate;

and the third operation unit is used for performing multiplication operation on the first operation result and the second operation result to obtain a quantum entangled state of the node route diagram.

Optionally, the generating module 403 includes:

the obtaining unit is used for acquiring the quantum resource state corresponding to the node route diagram;

and the cutting unit is used for cutting the quantum resource state based on the node route diagram to obtain the quantum entangled state of the node route diagram.

The function processing device 400 provided in the present disclosure can implement each process implemented by the function processing method embodiment, and can achieve the same beneficial effects, and for avoiding repetition, the details are not repeated here.

According to embodiments of the present disclosure, an electronic device, a readable storage medium, and a computer program product are also provided.

FIG. 5 illustrates a schematic block diagram of an example electronic device 500 that can be used to implement embodiments of the present disclosure. Electronic devices are intended to represent various forms of digital computers, such as laptops, desktops, workstations, personal digital assistants, servers, blade servers, mainframes, and other appropriate computers. Electronic devices may also represent various forms of mobile devices, such as personal digital processors, cellular telephones, smart phones, wearable devices, and other similar computing devices. The components shown herein, their connections and relationships, and their functions, are meant to be exemplary only, and are not meant to limit implementations of the present disclosures described and/or claimed herein.

As shown in FIG. 5, the device 500 comprises a computing unit 501 which may perform various suitable actions and processes according to a computer program stored in a Read Only Memory (ROM) 502 or a computer program loaded from a storage unit 508 into a Random Access Memory (RAM) 503. In the RAM503, various programs and data necessary for the operation of the device 500 can also be stored. The computing unit 501, the ROM502, and the RAM503 are connected to each other via a bus 504. An input/output (I/O) interface 505 is also connected to bus 504.

A number of components in the device 500 are connected to the I/O interface 505, including: an input unit 506 such as a keyboard, a mouse, or the like; an output unit 507 such as various types of displays, speakers, and the like; a storage unit 508, such as a magnetic disk, optical disk, or the like; and a communication unit 509 such as a network card, modem, wireless communication transceiver, etc. The communication unit 509 allows the device 500 to exchange information/data with other devices via a computer network such as the internet and/or various telecommunication networks.

The computing unit 501 may be a variety of general and/or special purpose processing components with processing and computing capabilities. Some examples of the computing unit 501 include, but are not limited to, a Central Processing Unit (CPU), a Graphics Processing Unit (GPU), various dedicated Artificial Intelligence (AI) computing chips, various computing units running machine learning model algorithms, a Digital Signal Processor (DSP), and any suitable processor, controller, microcontroller, and so forth. The calculation unit 501 performs the respective methods and processes described above, such as a function processing method. For example, in some embodiments, the function handling method may be implemented as a computer software program tangibly embodied in a machine-readable medium, such as storage unit 508. In some embodiments, part or all of the computer program may be loaded and/or installed onto device 500 via ROM502 and/or communications unit 509. When the computer program is loaded into the RAM503 and executed by the computing unit 501, one or more steps of the function processing method described above may be performed. Alternatively, in other embodiments, the computing unit 501 may be configured to perform the function processing method by any other suitable method (e.g., by means of firmware).

Various implementations of the systems and techniques described here above may be implemented in digital electronic circuitry, integrated circuitry, Field Programmable Gate Arrays (FPGAs), Application Specific Integrated Circuits (ASICs), Application Specific Standard Products (ASSPs), system on a chip (SOCs), load programmable logic devices (CPLDs), computer hardware, firmware, software, and/or combinations thereof. These various embodiments may include: implemented in one or more computer programs that are executable and/or interpretable on a programmable system including at least one programmable processor, which may be special or general purpose, receiving data and instructions from, and transmitting data and instructions to, a storage system, at least one input device, and at least one output device.

Program code for implementing the methods of the present disclosure may be written in any combination of one or more editing languages. These program code may be provided to a processor or controller of a general purpose computer, special purpose computer, or other programmable data processing apparatus, such that the program code, when executed by the processor or controller, causes the functions/acts specified in the flowchart and/or block diagram to be performed. The program code may execute entirely on the machine, partly on the machine, as a stand-alone software package, partly on the machine and partly on a remote machine or entirely on the remote machine or server.

In the context of this disclosure, a machine-readable medium may be a tangible medium that can contain, or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a machine-readable storage medium would include an electrical connection based on one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

To provide for interaction with a user, the systems and techniques described here can be implemented on a computer having: a display device (e.g., a CRT (cathode ray tube) or LCD (liquid crystal display) monitor) for displaying information to a user; and a keyboard and a pointing device (e.g., a mouse or a trackball) by which a user may provide input to the computer. Other kinds of devices may also be used to provide for interaction with a user; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a user computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include: local Area Networks (LANs), Wide Area Networks (WANs), the Internet, and blockchain networks.

The computer system may include clients and servers. A client and server are generally remote from each other and typically interact through a communication network. The relationship of client and server arises by virtue of computer programs running on the respective computers and having a client-server relationship to each other. The Server may be a cloud Server, also called a cloud computing Server or a cloud host, and is a host product in a cloud computing service system, so as to solve the defects of high management difficulty and weak service extensibility in a traditional physical host and VPS service (“Virtual Private Server”, or “VPS” for short). The server may also be a server of a distributed system, or a server incorporating a blockchain.

It should be understood that various forms of the flows shown above, reordering, adding or deleting steps, may be used. For example, the steps described in the present disclosure may be executed in parallel, sequentially, or in different orders, and are not limited herein as long as the desired results of the technical solutions disclosed in the present disclosure can be achieved.

The above-described embodiments are not intended to limit the scope of the present disclosure. It should be understood by those skilled in the art that various modifications, combinations, sub-combinations and substitutions may be made, depending on design requirements and other factors. Any modification, equivalent replacement, and improvement made within the spirit and principle of the present disclosure shall be included in the protection scope of the present disclosure.

What is claimed is:

1. A function processing method, comprising:
obtaining a first polynomial function comprising a plurality of terms consisting of a plurality of first variables;
constructing a node route diagram of a quantum approximate optimization algorithm (QAOA) based on the first polynomial function, wherein the node route diagram comprises K nodes, K is determined based on the first polynomial function, and K is an integer greater than 1;
generating quantum entangled states of the node route diagram, wherein the quantum entangled states comprise target quantum states of the K nodes in the node route diagram; and
sequentially performing a numerical measurement on each node in the K nodes based on the target quantum state of the K nodes in the node route diagram, to obtain a first target numerical measurement result of the plurality of first variables.

2. The method according to claim 1, wherein constructing the node route diagram of the QAOA based on the first polynomial function comprises:
constructing node graphs based on the first polynomial function, wherein the node graphs comprise M nodes, and M is determined based on the first polynomial function; and
repeatedly stacking the node graphs in parallel and sequentially, to form a node route diagram of the QAOA, wherein the K nodes comprise the M nodes, and K is an integer greater than or equal to M.

3. The method according to claim 2, wherein the constructing the node graphs based on the first polynomial function comprises:
performing, based on a preset variable relation, variable replacement processing on a first variable in the first polynomial function, to obtain a second polynomial function, wherein the second polynomial function comprises a plurality of terms consisting of a plurality of second variables, and the second variables and the first variables meet the preset variable relation;
creating Q first nodes and Q second nodes, wherein the Q first nodes are in a one-to-one correspondence with the Q second nodes, the Q second nodes are in a one-to-one correspondence with the plurality of second variables, and Q is an integer greater than 1; and
constructing the node graphs based on the Q first nodes and the Q second nodes, wherein the node graphs comprise the Q first nodes which are sequentially and longitudinally arranged, the Q second nodes which are sequentially and longitudinally arranged, and undirected edges which connect the first nodes and the second nodes which are arranged side by side, and the M nodes comprise the Q first nodes and the Q second nodes.

4. The method according to claim 3, wherein in a case that the plurality of terms consisting of the plurality of second variables comprises terms of at least two second variables, prior to constructing the node graphs based on the Q first nodes and the Q second nodes, the method further comprises:
creating L third nodes, wherein the L third nodes are in a one-to-one correspondence with items comprising at least two second variables in the plurality of terms consisting of the second variables, and L is a positive integer;
for each third node in the L third nodes, respectively connecting the third node with at least two target nodes to obtain undirected edges between the third node and the at least two target nodes, wherein the target node is the first node in the Q first nodes, which corresponds to a second variable in a term corresponding to the third node; and
wherein the node graphs further comprise the L third nodes and undirected edges between the L third nodes and the target node, and the M nodes further comprise the L third nodes.

5. The method according to claim 4, wherein sequentially performing the numerical measurement on each node in the K nodes based on the target quantum state of the K nodes in the node route diagram to obtain the first target numerical measurement result of the plurality of first variables comprises:
sequentially performing, based on the target quantum states of the K nodes in the node route diagram, the numerical measurement on each node in the node route diagram according to a stacking sequence of the node graphs in the node route diagram to obtain the numerical measurement result of the K nodes; and
determining a first target numerical measurement result of the plurality of first variables based on the numerical measurement result of the K nodes.

6. The method according to claim 5, wherein the node graphs in the node route diagram comprise a first node graph, the first node graph is any one of the node graphs in the node route diagram, and sequentially performing, based on the target quantum states of the K nodes in the node route diagram, the numerical measurement on each node in the node route diagram according to the stacking sequence comprises:
for each third node in the first node graph, performing the numerical measurement on the third node in a first target measurement mode based on the target quantum state of the third node in the node route diagram to obtain a numerical measurement result of the third node in the first node graph, wherein the first target measurement mode is a measurement mode in which a measurement angle in the first measurement mode is determined based on a numerical measurement result of a second node in a second node graph corresponding to the third node, a coefficient in a term corresponding to the third node, and first angle information, and the second node graph is a node graph stacked before the first node graph;
for each first node in the first node graph, performing the numerical measurement on the first node in a second target measurement mode based on a target quantum state of the first node in the node route diagram to obtain a numerical measurement result of the first node in the first node graph, wherein the second target measurement mode is a measurement mode in which a measurement angle in the second measurement mode is determined based on a numerical measurement result of a second node corresponding to the first node in the second node graph, a coefficient in a term of a second variable corresponding to the first node, and the first angle information; and
for each second node in the first node graph, performing numerical measurement on the second node in a third target measurement mode based on a target quantum state of the second node in the node route diagram to obtain a numerical measurement result of the second node in the first node graph, wherein the third target measurement mode is a measurement mode in which a measurement angle in the second measurement mode is determined based on a numerical measurement result of a third node related to a second variable corresponding to the second node in a third node graph, a numerical measurement result of a first node corresponding to the second node in the third node graph and second angle information, and the third node graph comprises the first node graph and the second node graph.

7. The method according to claim 5, wherein determining the first target numerical measurement result of the plurality of first variables based on the numerical measurement result of the K nodes comprises:
for each first variable in the plurality of first variables, summing the numerical measurement results of a second node corresponding to a target variable in a node graph of the node route diagram to obtain a target value corresponding to the first variable; and performing modular operation on the target value to obtain a first target numerical measurement result of the first variable, wherein the target variable is a second variable which has the preset variable relation with the first variable.

8. The method according to claim 3, wherein generating the quantum entangled states of the node route diagram comprises:
generating a quantum state for each of the K nodes;
performing a tensor product operation based on the quantum state of each node in the K nodes to obtain a first operation result;
performing tensor product and matrix multiplication operations on the T pieces of control information to obtain a second operation result, wherein T is determined based on the number of the undirected edges included in the node route diagram, and the control information is information corresponding to the control Z gate; and
performing a multiplication operation on the first operation result and the second operation result to obtain a quantum entangled state of the node route diagram.

9. The method according to claim 3, wherein generating the quantum entangled states of the node route diagram comprises:
obtaining a quantum resource state corresponding to the node route diagram;
cutting the quantum resource state based on the node route diagram to obtain the quantum entangled state of the node route diagram.

10. The method according to claim 1, wherein sequentially performing the numerical measurement on each node in the K nodes based on the target quantum state of the K nodes in the node route diagram comprises:
executing a target measurement operation N times to obtain N second target numerical measurement results of the plurality of first variables, wherein N is a positive integer, and the target measurement operation comprises sequentially performing the numerical measurement on each node in the K nodes based on the target quantum state of the K nodes in the node route diagram;
determining a first target function value based on the N second target numerical measurement results, wherein the first target function value is used for representing numerical measurement score conditions of the plurality of first variables in N times of executing target measurement operation;
updating angle information in the target measurement operation based on the first target function value, wherein the angle information is configured to determine a measurement angle for performing numerical measurement on each node in the K nodes in the target measurement operation;
performing the target measurement operation N times again based on the updated angle information to determine a second target function value; and
determining a measurement result with the highest occurrence frequency in the N second target numerical measurement results as a first target numerical measurement result of the plurality of first variables when a difference between the first target function value and the second target function is smaller than a preset threshold value.

11. A function processing device, comprising:
at least one processor; and
a memory communicatively coupled to the at least one processor; wherein
the memory stores instructions executable by the at least one processor to enable the at least one processor to:
obtain a first polynomial function comprising a plurality of terms consisting of a plurality of first variables;
construct a node route diagram of a quantum approximate optimization algorithm (QAOA) based on the first polynomial function, wherein the node route diagram comprises K nodes, K is determined based on the first polynomial function, and K is an integer greater than 1;
generate quantum entangled states of the node route diagram, wherein the quantum entangled states comprise target quantum states of the K nodes in the node route diagram; and
sequentially perform a numerical measurement on each node in the K nodes based on the target quantum state of the K nodes in the node route diagram, to obtain a first target numerical measurement result of the plurality of first variables.

12. The device according to claim 11, wherein the memory stores instructions executable by the at least one processor to enable the at least one processor to:
construct node graphs based on the first polynomial function, wherein the node graphs comprise M nodes, and M is determined based on the first polynomial function; and
repeatedly stack the node graphs in parallel and sequentially, to form a node route diagram of the QAOA, wherein the K nodes comprise the M nodes, and K is an integer greater than or equal to M.

13. The device according to claim 12, wherein the memory stores instructions executable by the at least one processor to enable the at least one processor to:
perform, based on a preset variable relation, variable replacement processing on a first variable in the first polynomial function, to obtain a second polynomial function, wherein the second polynomial function comprises a plurality of terms consisting of a plurality of second variables, and the second variables and the first variables meet the preset variable relation;
create Q first nodes and Q second nodes, wherein the Q first nodes are in a one-to-one correspondence with the Q second nodes, the Q second nodes are in a one-to-one correspondence with the plurality of second variables, and Q is an integer greater than 1; and
construct the node graphs based on the Q first nodes and the Q second nodes, wherein the node graphs comprise the Q first nodes which are sequentially and longitudinally arranged, the Q second nodes which are sequentially and longitudinally arranged, and undirected edges which connect the first nodes and the second nodes which are arranged side by side, and the M nodes comprise the Q first nodes and the Q second nodes.

14. The device according to claim 13, wherein in a case that the plurality of terms consisting of the plurality of second variables comprises terms of at least two second variables, prior to constructing the node graphs based on the Q first nodes and the Q second nodes, the memory stores instructions executable by the at least one processor to enable the at least one processor to:
create L third nodes, where the L third nodes correspond to items, including at least two second variables, in a plurality of terms formed by the plurality of second variables in a one-to-one manner, and L is a positive integer;
for each third node in the L third nodes, respectively connect the third node with at least two target nodes to obtain undirected edges between the third node and the at least two target nodes, wherein the target node is the first node in the Q first nodes, which corresponds to a second variable in a term corresponding to the third node;
wherein the node graphs further comprise the L third nodes and undirected edges between the L third nodes and the target node, and the M nodes further comprise the L third nodes.

15. The device according to claim 14, wherein the memory stores instructions executable by the at least one processor to enable the at least one processor to:
sequentially perform, based on the target quantum states of the K nodes in the node route diagram, the numerical measurement on each node in the node route diagram according to a stacking sequence of the node graphs in the node route diagram to obtain the numerical measurement result of the K nodes;
determine a first target numerical measurement result of the plurality of first variables based on the numerical measurement result of the K nodes.

16. The device according to claim 15, wherein the node graphs in the node route diagram comprise a first node graph, the first node graph is any one of the node graphs in the node route diagram, and the memory stores instructions executable by the at least one processor to enable the at least one processor to:
for each third node in the first node graph, perform the numerical measurement on the third node in a first target measurement mode based on the target quantum state of the third node in the node route diagram to obtain a numerical measurement result of the third node in the first node graph, wherein the first target measurement mode is a measurement mode in which a measurement angle in the first measurement mode is determined based on a numerical measurement result of a second node in a second node graph corresponding to the third node, a coefficient in a term corresponding to the third node, and first angle information, and the second node graph is a node graph stacked before the first node graph;
for each first node in the first node graph, perform the numerical measurement on the first node in a second target measurement mode based on a target quantum state of the first node in the node route diagram to obtain a numerical measurement result of the first node in the first node graph, wherein the second target measurement mode is a measurement mode in which a measurement angle in the second measurement mode is determined based on a numerical measurement result of a second node corresponding to the first node in the second node graph, a coefficient in a term of a second variable corresponding to the first node, and the first angle information; and
for each second node in the first node graph, perform numerical measurement on the second node in a third target measurement mode based on a target quantum state of the second node in the node route diagram to obtain a numerical measurement result of the second node in the first node graph, wherein the third target measurement mode is a measurement mode in which a measurement angle in the second measurement mode is determined based on a numerical measurement result of a third node related to a second variable corresponding to the second node in a third node graph, a numerical measurement result of a first node corresponding to the second node in the third node graph and second angle information, and the third node graph comprises the first node graph and the second node graph.

17. The device according to claim 15, wherein the memory stores instructions executable by the at least one processor to enable the at least one processor to:
for each first variable in the plurality of first variables, sum the numerical measurement results of a second node corresponding to a target variable in a node graph of the node route diagram to obtain a target value corresponding to the first variable;
and performing modular operation on the target value to obtain a first target numerical measurement result of the first variable, wherein the target variable is a second variable which has the preset variable relation with the first variable.

18. The device according to claim 13, wherein the memory stores instructions executable by the at least one processor to enable the at least one processor to:
generate a quantum state for each of the K nodes;
perform a tensor product operation based on the quantum state of each node in the K nodes to obtain a first operation result;
perform tensor product and matrix multiplication operations on the T pieces of control information to obtain a second operation result, wherein T is determined based on the number of the undirected edges included in the node route diagram, and the control information is information corresponding to the control Z gate; and
perform a multiplication operation on the first operation result and the second operation result to obtain a quantum entangled state of the node route diagram.

19. The device according to claim 13, wherein the memory stores instructions executable by the at least one processor to enable the at least one processor to:
acquire the quantum resource state corresponding to the node route diagram;
cut the quantum resource state based on the node route diagram to obtain the quantum entangled state of the node route diagram.

20. The device according to claim 11, wherein the memory stores instructions executable by the at least one processor to enable the at least one processor to:
execute a target measurement operation N times to obtain N second target numerical measurement results of the plurality of first variables, wherein N is a positive integer, and the target measurement operation comprises sequentially performing the numerical measurement on each node in the K nodes based on the target quantum state of the K nodes in the node route diagram;
determine a first target function value based on the N second target numerical measurement results, wherein the first target function value is used for representing numerical measurement score conditions of the plurality of first variables in N times of executing target measurement operation;
update angle information in the target measurement operation based on the first target function value, wherein the angle information is configured to determine a measurement angle for performing numerical measurement on each node in the K nodes in the target measurement operation;
perform the target measurement operation N times again based on the updated angle information to determine a second target function value; and
determine a measurement result with the highest occurrence frequency in the N second target numerical measurement results as a first target numerical measurement result of the plurality of first variables when a difference between the first target function value and the second target function is smaller than a preset threshold value.
